(19) United States
(12) Patent Application Publication
(10) Pub. No.: US 2012/0283914 A1
(43) Pub. Date: Nov. 8, 2012

(54) VEHICLE STEERING WHEEL CONTROL SYSTEM HAVING INTEGRATED ELECTRONIC CONTROL UNIT

(76) Inventor: Krzysztof W. Karwaczynski, Sterling Heights, MI (US)

(21) Appl. No.: 13/101,875

(22) Filed: May 5, 2011

(51) Int. Cl. B62D 6/00

(52) U.S. Cl. 701/41

(57) ABSTRACT

A steering wheel control system and control method for a vehicle are provided. One control system includes a steering wheel and one or more controls actuatable by an operator. The vehicle control system also includes an integrated steering wheel controller having a processor and connected to the one or more controls and to a vehicle computer. The vehicle control system further includes an indicator corresponding to the one or more controls and providing a visual indication of a state of an operation or function associated with the one or more controls.

### BACKGROUND OF THE INVENTION

The subject matter disclosed herein relates generally to vehicle steering wheels, and more particularly to switches or other controls provided as part of the steering wheel assembly.

Steering wheels for vehicles, such as steering wheel/driver airbag assemblies often include controls that may be activated by the vehicle operator. For example, one or more switches or other depressible controls may be provided on a front face of the steering wheel. These controls may be illuminated to provide easier locating by an operator in dark conditions, such as when driving at night.

In conventional electrical wiring arrangements for the steering wheel switches or buttons, each switch or button typically includes at least two wires for connection to the vehicle control system. For example, two wires connect each of the switches with an electronic control unit (ECU) to communicate signals back and forth. Thus, with each added steering control, additional wires are needed for connection between the control at the steering wheel face and the ECU. Accordingly, ten, twenty or even more wires may be needed to provide the necessary connections. These wires are provided as part of flex ribbon cables that connect to a clock spring within the vehicles steering wheel. As the number of wire traces in the flex ribbon cables providing the electrical connections to and from the steering wheel increases, the size of the flex ribbon cable must increase, which results in added design complexity and cost. Additional pins on the clock spring connectors also must be added. Accordingly, a bundle of ten, twenty or more wires have to be added to a harness. The main control unit (e.g., CPU) of a vehicle also has to accommodate all of the additional wires, requiring a new connector and plug, which often results in a very high cost for new features within a steering wheel.

Accordingly, as the demand for positioning more switches on the steering wheel body increases, as well as providing more functionality in connection with those switches, the complexity and cost of conventional connection arrangements will increase.

### BRIEF DESCRIPTION OF THE INVENTION

In accordance with various embodiments, a vehicle control system is provided that includes a steering wheel and one or more controls actuatable by an operator. The vehicle control system also includes an integrated steering wheel controller having a processor and connected to the one or more controls and to a vehicle computer. The vehicle control system further includes an indicator corresponding to the one or more controls and providing a visual indication of a state of an operation or function associated with the one or more controls.

In accordance with other embodiments, a steering wheel assembly is provided that includes a steering wheel, an airbag module configured to be coupled to the steering wheel and a microprocessor mounted within the steering wheel and connected to a vehicle computer. The steering wheel assembly also includes a plurality of backlit control buttons on the steering wheel connected to the microprocessor and configured to be actuated by an operator, wherein a color of the backlighting corresponds to an activation state of an operation or function controlled by the backlit control button.

In accordance with yet other embodiments, a method for providing vehicle function and indication control includes receiving a control input at a steering wheel for a vehicle and communicating a control signal corresponding to the received control input from a processor within the steering wheel to a main computer of the vehicle. The method also includes transmitting a confirmation signal from the main computer to the processor within the steering wheel indicating activation of an operation or function corresponding to the received control input. The method further includes providing a visual confirmation at the steering wheel based on the confirmation signal.

### BRIEF DESCRIPTION OF THE DRAWINGS

FIG. 1 is a block diagram of a signal communication arrangement having an integrated steering wheel controller formed in accordance with various embodiments.

FIG. 2 is a top plan view of a steering wheel with a steering wheel/airbag assembly and having a signal communication arrangement formed in accordance with various embodiments.

FIG. 3 is an exploded view of a steering wheel/airbag assembly having a signal communication arrangement in accordance with one embodiment.

FIG. 4 is another exploded view of a steering wheel/airbag assembly having a signal communication arrangement in accordance with one embodiment.

FIG. 5 is a simplified schematic diagram of a steering wheel having a signal communication arrangement formed in accordance with various embodiments.

FIG. 6 is a side view of a steering wheel having a signal communication arrangement formed in accordance with various embodiments.

FIG. 7 is a block diagram illustrating a control configuration for a signal communication arrangement in accordance with one embodiment.

FIG. 8 is a flowchart of a method for vehicle function and indication control in accordance with various embodiments.

### DETAILED DESCRIPTION OF THE INVENTION

The foregoing summary and brief description of drawings, as well as the following detailed description of certain embodiments, will be better understood when read in conjunction with the appended drawings. To the extent that the figures illustrate diagrams of the functional or operational blocks of various embodiments, the functional or operational blocks are not necessarily indicative of the division between hardware or circuitry. Thus, for example, one or more of the functional or operational blocks may be implemented in a single piece of hardware or multiple pieces of hardware. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Various embodiments provide an integrated steering wheel controller communicating signal information with a main vehicle computer, which includes communication function and indication control information relating to control devices (e.g. switches) provided as part of the steering wheel. By practicing at least one embodiment, a reduced number of electrical wires are used between the steering wheel, and in particular, the steering wheel controls, and the main vehicle computer.

FIG. 1 illustrates a simplified block diagram of a signal communication arrangement 20 (also referred to as a communication arrangement 20) formed in accordance with one embodiment that provides function and indication control. The communication arrangement 20 may be embodied as a steering wheel vehicle control system. The communication arrangement 20 provides communication of signals received at a steering wheel 22 to a computer of a vehicle, such as the main computer of the vehicle, illustrated in this embodiment as an electronic control unit (ECU) 24. In particular, a plurality of controls 26 is provided in connection with the steering wheel 22. For example, the controls 26 may include a plurality of operator actuated (or actuatable) switches or buttons that may be used to control different functions or operations of the vehicle as described in more detail herein. The controls 26 may be any type of control that may be mounted or otherwise coupled to a surface of the steering wheel 22, such as a front face or surface of the steering wheel and that are adapted to receive a user input, such as by depression of one or more of the controls 26.

An indicator 28 may be provided in combination with each of the controls 26 to provide to an operator some type of visual indicator. For example, the indicators 28 may provide background illumination for the controls 26 using one or more light emitting diodes (LEDs), which in various embodiments are used to indicate or signal to a user that a particular function or operation selected or actuated by the respective control 26 has been initiated and/or performed. It should be noted that the indicators 28 may be provided separate from or integrated with the controls 26.

Each of the controls 26 includes a plurality of communication lines 30 (e.g., signal wires), which in the illustrated embodiment is two communication lines 30 for each of the controls 26. The communication lines 30 may be any suitable electrical lines that provide signals to and from the controls 26. The indicators 28 may be connected to the communication lines 30 or may have separate electrical lines, for example, to power and/or control the indicators 28.

The communication lines 30 are connected to an integrated steering wheel controller 32, which in this embodiment is illustrated as a microcontroller (MCU) that is coupled to or built into the body of the steering wheel 22. It should be noted that the integrated steering wheel controller 32 may be any type of processing device, such as a single integrated circuit or microprocessor unit that is programmable to communicate function and indication controls between the controls 26, the indicators 28 and the ECU 24. The integrated steering wheel controller 32 may be a simple multiplexing controller or may include logic that provides processing and control capabilities as described in more detail herein.

In various embodiments, the integrated steering wheel controller 32 includes a plurality of communication lines 34 that provide communication of the signals between the integrated steering wheel controller 32 and the ECU 24. The communication lines 34 may form, for example, a wiring harness that connects to a connector 36 (e.g., pins of a connector) of a clock spring 38. The clock spring 38 is a rotary electrical connector that allows the steering wheel 22 to turn while making an electrical connection between the steering wheel 22 (namely the communication lines 34 and any other electrical lines, such as for the vehicle horn or other devices) and other electrical systems of the vehicle, which include in this embodiment at least the ECU 24. The clock spring 38 is located between the steering wheel 22 and a steering column (not shown).

It should be noted that the ECU 24 may be in communication with different components or devices of the vehicle. For example, although the ECU 24 is illustrated as connected with the controls 26, the ECU 24 may be in communication with, for example, an airbag inflator, a vehicle horn, etc. The ECU 24 is responsive to input signals, such as received at the controls 26 and communicated to the ECU 24 via the integrated steering wheel controller 32. Thus, the ECU 24 may actuate different functions or operations of the vehicle (e.g., cruise control, traction control, a sport mode, etc.) based on signals from the integrated steering wheel controller 32 corresponding to inputs received at the controls 26 (e.g., a button depression by an operator). The ECU 24 also may provide signals to the integrated steering wheel controller 32, such as confirmation signals that a particular operation or function corresponding to an operator input received at the controls 26 has been performed. The integrated steering wheel controller 32 may then provide a visual indication to the operator based on the received confirmation signal using the indicator 28 corresponding to the switch 26 that received the operator input. For example, in one embodiment, the indicator is a multicolor LED that changes color based on whether a particular operation or function has been performed based on the activation by the operator with the control 26.

As can be seen in FIG. 1, the communication arrangement 20 provides a reduced number of communication lines 34 between the steering wheel 22 and the ECU 24. For example, as illustrated, each of the controls 26 and/or control 26/indicator 28 combination have a plurality of communication lines, illustrated as two electrical wires, connecting the controls 26 and/or control 26/indicator 28 combinations to the integrated steering wheel controller 32. Thus, in the illustrated embodiment having four controls 26, a total of eight communication lines 30 are provided for communicating signals and/or power to and from the controls 26 and/or control 26/indicator 28 combinations. As can further be seen in FIG. 1, the integrated steering wheel controller 32 has a plurality of communication lines, illustrated as three electrical lines that connect the clock spring 38. Accordingly, in various embodiments, the integrated steering wheel controller 32 includes logic or other multiplexing operations that allow for a reduced number of signal lines. In various embodiments, a total of N communication lines 30 are provided and total of M communication lines 34 are provided, with M less than N. However, the various embodiments are not limited to such an arrangement or to a particular number of communication lines 30 and 34.

Thus, in operation, various embodiments of the communication arrangement 20 provide signal communication between the steering wheel 22 and the ECU 24 with a reduced number of communication lines 34 by using the integrated steering wheel controller 32. Additionally, an indication is provided in connection with an operation or function selected by a particular control 26 that indicates that the corresponding operation or function has been performed.

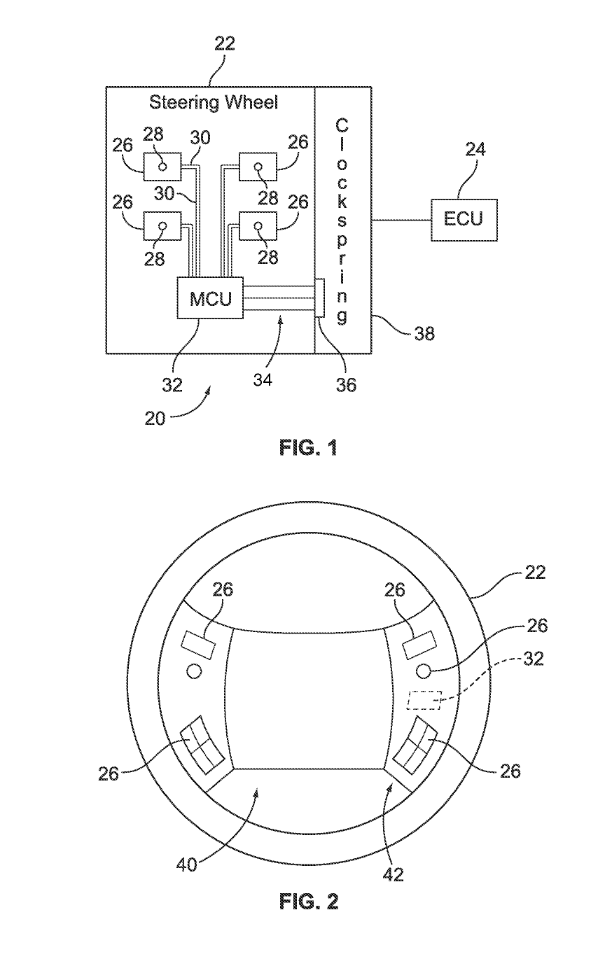

For example, FIG. 2 illustrates an embodiment of the invention in combination with a steering wheel/airbag assembly 40 mounted to the steering wheel 22 (which may also be referred to herein as a steering wheel assembly). The steering wheel/airbag assembly 40 may be, for example, a module mounted to a center portion of the steering wheel 22 with the controls 26 positioned adjacent to or surrounding the steering wheel/airbag assembly 40 along outer regions 42 closer to the steering wheel 22.

In this embodiment, the controls 26 are buttons capable of depression by an operator, and may be any suitable type of automotive switches or controls that allow illumination by the indicators 28 (shown in FIG. 1), which are mounted below the controls 26. The controls 26 may be simple depressible buttons or may provide different operations, such as by moving the controls 26 in different direction or by pressing different portions of the controls 26. The controls 26 also may include indicia (e.g., arrows) or labels thereon to indicate a particular function or operation that is controllable by the particular control 26.

It should be noted that the controls 26 may have a fixed function or operation such that actuating the control 26 activates the same function or operation in multiple modes of operation. However, the function or operation controllable by the controls 26 may change based on a particular mode of operation, that also may be selected by one of the controls 26. For example, a pair of controls 26 may be provided that increase or decrease a selected function in the particular mode of operation. As another example, a particular control 26 may turn on or off a particular operation or function.

As can be seen in phantom, a single integrated steering wheel controller 32 is provided in connection with the controls 32. It should be noted that more than one integrated steering wheel controller 32 may be provided, for example, one on each side of the steering wheel 22. The multiple integrated steering wheel controllers 32 may be separately connected to the clock spring 38 or may be routed or combined and connected as a single connector, for example, as a single wiring harness to the clock spring 38.

The integrated steering wheel controller 32 may be mounted or coupled to the steering wheel 22 using any suitable fastening or securing means. For example, in one embodiment, a bracket (not shown) may be used to mount the integrated steering wheel controller 32 to an inner surface of the steering wheel 22. However, securing means such as glue or other bonding materials may be used. In some embodiments, the integrated steering wheel controller 32 is formed integral with the steering wheel 22.

It should be noted that the number, arrangement and/or positioning of the controls 26 is merely exemplary. Accordingly, any suitable or desirable arrangement of controls 26 may be provided that controls different vehicle operations or functions.

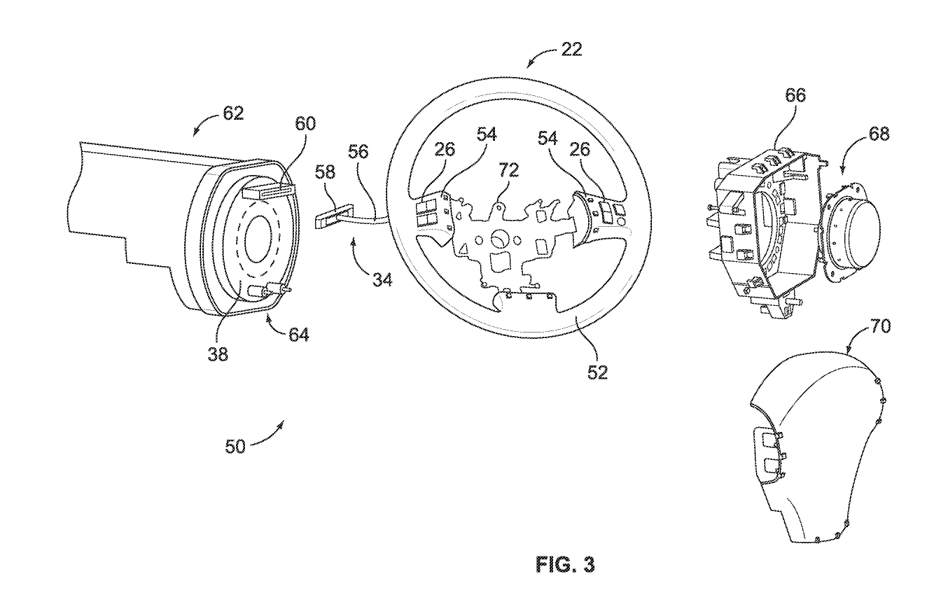

FIG. 3 is an exploded view of a steering wheel and airbag assembly 50 in which the various embodiments may be implemented. In this embodiment, the steering wheel 22 may be formed from a steering wheel armature having an armature overmold 52. The overmold 52 may include the controls 26 formed thereon or coupled thereto, such as on arms 54 extending radially inwardly from the steering wheel 22. The integrated steering wheel controller 32 (shown in FIGS. 1 and 2) may be coupled or mounted within one or the arms 54, which in this embodiment is within the left arm 54 under the overmold 52. For example, the integrated steering wheel controller 32 may be coupled or mounted to the steering wheel armature.

As can be seen, the communication lines 34 extend from the integrated steering wheel controller 32 and may be embodied as a wiring harness 56 having a mating connector 58. The connector 58 is configured to engage a complementary connector 60 (e.g., a pin connector) of the clock spring 38. For example, the connectors 58 and 60 may be provided in a male-female arrangement to coupled together and provide electrical connection between the integrated steering wheel controller 32 and the clock spring 38.

The clock spring 38 forms part of the steering wheel column 62 and provides the electrical connection between the steering wheel 22 and vehicle computers or processors, such as the ECU 24 (shown in FIG. 1). The clock spring 38 may be embodied, for example, as a wound bundle of wires that allows the steering wheel 22 to rotate freely while providing electrical connection to steering wheel mounted electrical devices, such as the controls 26, other different switches, as well as other components such as an airbag deployment apparatus and devices that provide actuation, but are not part of the controls 26, for example, a horn switch. It should be noted that the components and devices that are not part of the controls 26 may also be connected to the clock spring 38 via the integrated steering wheel controller 32. However, optionally, one or more other connectors 64 may be provided to connect the components and devices that are not part of the controls 26 to the clock spring 38.

A conduit or other passage (not shown) and which may be provided within the steering column 62 provides has therein the electrical lines that connect the clock spring 38 to the vehicle controllers or computers, such as the ECU 24. It should be noted that the ECU 24 generally allows interfacing between the steering wheel 22 and other components within the vehicle.

The steering wheel and airbag assembly 50 also includes an airbag housing 66 having an airbag inflator 68 therein. An airbag cover 70 couples to the airbag housing 66 (with the airbag inflator 68 inside the airbag housing 66). The airbag inflator 68 and the airbag housing 66 are together mounted within the steering wheel 22 to a mounting portion 72 forming part of the steering wheel armature, which may define a bracket.

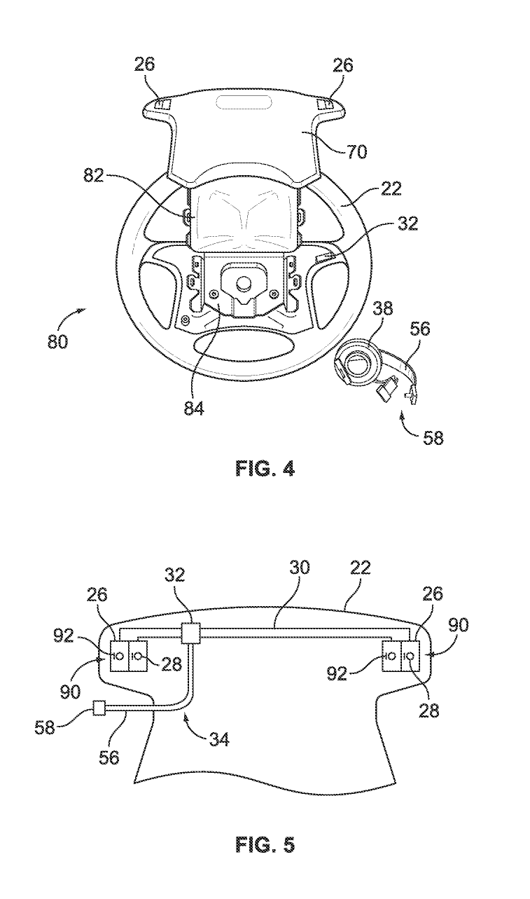

Various embodiments may provide communication of signals as part of an airbag module 80 as shown in FIG. 4 that is mounted within the steering wheel 22. In this embodiment, the cover 70 may optionally include the controls 26 with the integrated steering wheel controller 32 mounted within the steering wheel 22 or the cover 70. It should be noted that the integrated steering wheel controller 32, in addition to the wiring harness 56 (shown in FIG. 3), may also include a similar wiring harness (not shown) for connecting the integrated steering wheel controller 32 to the controls 26 via the communication lines 30 (shown in FIG. 1).

An airbag assembly 82, which may be formed from the airbag housing 66 and the airbag inflator 68 (both shown in FIG. 3) is mounted to the steering wheel 22 under the cover 70. A retainer 84 is coupled to the steering wheel 22, and the clock spring 38 is mounted to a back side of the retainer 84, with the airbag assembly 82 mounted to a front side of the retainer 84.

Thus, as shown in FIG. 5, illustrating a simplified schematic block diagram, a single integrated steering wheel controller 32 may be provided in connection with all of the controls 26. In this embodiment, the controls 26 may be formed from modules 90 that also include the indicators 28 and a switching device 92, such as a switch that may be operated by depression of a corresponding button or switch. As can be seen, the integrated steering wheel controller 32 includes connections for connecting to the various modules 90, as well as the wiring harness 56 having the communication lines 34 for connection to the clock spring 38 (shown in FIGS. 1, 3 and 4).

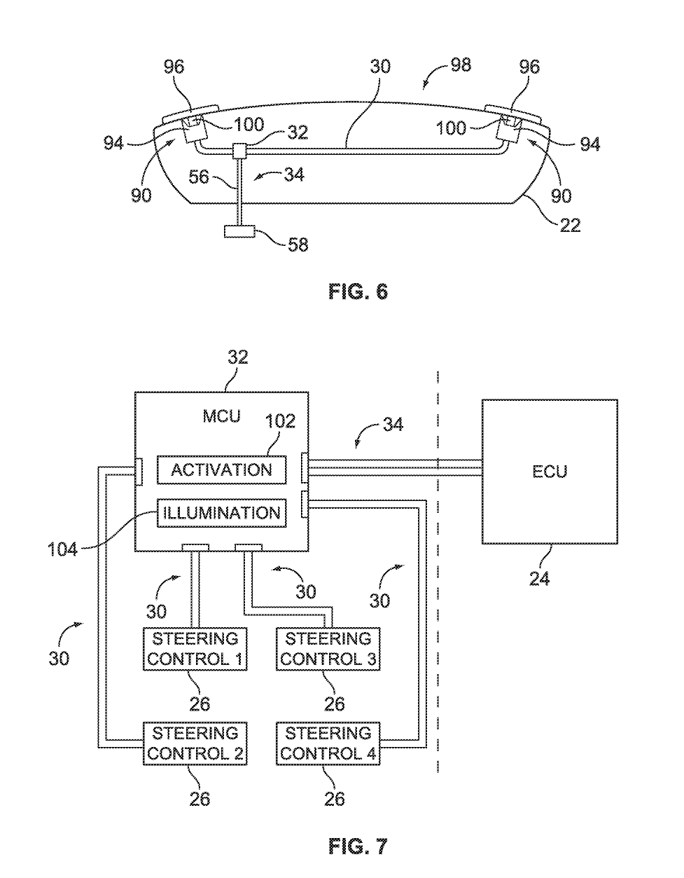

Thus, as shown in FIG. 6, the modules 90 may include a depressible switch 94 coupled to a corresponding button 96 on a front face 98 of the steering wheel. 22. The modules 90 also provide back illumination of the buttons 96, which in this embodiment are provided by LEDs 100. For example, the LEDs 100 may be multi-colored LEDs that change color to provide a visible indicator to an operator, such as a current state of an operation or function corresponding to the particular button 96. Thus, the buttons 96 may be backlit control buttons.

Thus, in operation, vehicle signal communication and control may be provided with operator inputs via the steering wheel controls 26. As shown in FIG. 7, the integrated steering wheel controller 32 is an LED controller-MCU that is coupled or built into the steering wheel 22. However, as described in more detail herein, the level of processing provided by the integrated steering wheel controller 32 may range from a simple multiplexing operation to higher level processing and control.

In the embodiment of FIG. 7, the integrated steering wheel controller 32 may include one or more modules that may be implemented in hardware, software or a combination thereof. The modules in one embodiment are an activation module 102 and an illumination module 104. The integrated steering wheel controller 32 with the modules 102 and 104 may be configured to implement the method 110 described below for vehicle function and indication control.

In general, the activation module 102 provides the control for communicating operator inputs received at the controls 26 to the ECU 24 to initiate or activate vehicle operations or functions (e.g., traction control, sport mode, etc.). The illumination module 104 provides the control to change the illumination associated with each of the controls 26 to indicate to the operator the current state of the operation or function associated with the controls 26. It should be noted that communication of signals in the various embodiments may be provided using any suitable communication protocol. For example, the communication may be provided via a vehicle bus for an internal communications network that interconnects components inside the vehicle with a suitable protocol, such as a Controller Area Network (CAN) or Local Interconnect Network (LIN), among others. It should be noted that the communication is not limited to hard wired connections. For example, in various embodiments, wireless communication, such as using wireless communication networks may be provided. In another embodiment, an optical interface using, for example, optical fibers, for optical communications may be provided.

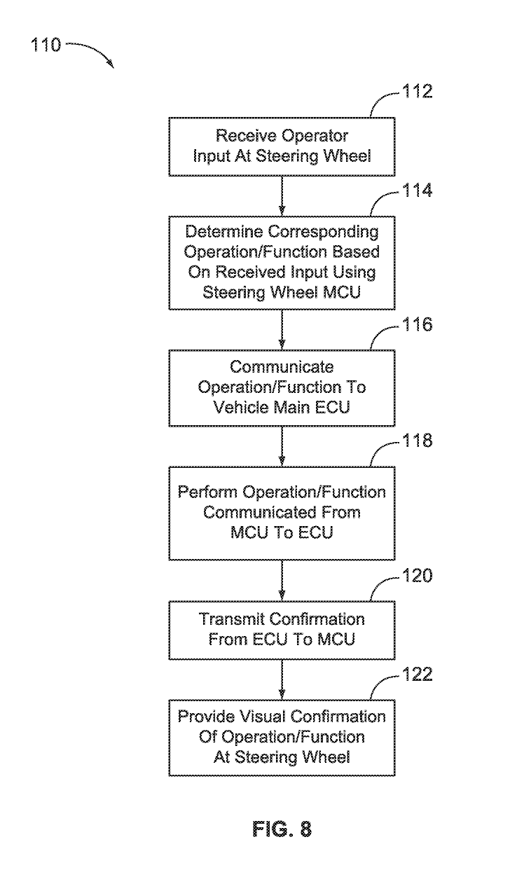

The vehicle function and indication control may be provided using the method 110 shown in FIG. 8. In particular, the method 110 includes receiving an operator input at a steering wheel at 112. For example, a user may depress a button on a steering wheel to activate an operation or function of the vehicle. The activation may occur while the vehicle is moving or stationary. The operation or function may be of any type. In some embodiments, the operation or function is one that the operator cannot readily ascertain or that is not readily apparent to the operator. For example, the operator may depress a button to activate a sport mode or particular traction mode of the vehicle, the activation of which is not necessarily immediately capable of being determined by the operator.

Thereafter at 114, the corresponding operation or function to be performed is determined at 114 based on the received operator input at the steering wheel. The determination in one embodiment is made by the integrated steering wheel controller. For example, based on the steering wheel control actuated, a look up table is accessed to determine a corresponding activation signal to send to the ECU. However, in other embodiments, the integrated steering wheel controller simply multiplexes received signals from the steering wheel controls and communicates the corresponding signal to the ECU. It also should be noted that the integrated steering wheel controller 32 may be programmable to allow different operations or functions to be performed by the same control 26.

Thereafter, when the operation or function has been determined, a corresponding activation signal is transmitted to the vehicle main ECU at 116. The ECU then may process the signal and perform the operation or function or transmit the appropriate control signals or commands to other components within the vehicle. Thus, the operation or function is performed at 118 based on the communication from, for example, the MCU to the ECU.

After the operation or function has been performed, for example, a change in state of a particular operation (such as a vehicle mode of operation), a confirmation signal is transmitted, for example, from the ECU to the MCU at 120. For example, the signal may indicate that the operation or function has been activated or performed. The MCU, which may form part of the integrated steering wheel controller, receives the confirmation signal of the activation of the operation or function, and provides a control signal. The control signal in one embodiment changes a state of an indicator associated with the control that received the operator input to thereby provide a visual confirmation of the performance of the operation or function at the steering wheel at 122. A multi-color LED may change colors based on the state of the operation or function. For example, when an operation or function corresponding to a button is off, the LED may be red and when the operation or function is activated or on, the LED is a different color, for example, green. Thus, a color of a background diode may be changed to provide a visual indication to the operator. In some embodiments, an on/off state of the LED may correspond to the on/off state of the operation or function.

Thus, in accordance with various embodiments, function and indication control for a steering wheel of a vehicle are provided. In the various embodiments, each selected function is indicated by providing specific lighting of a selected button on the steering wheel.

The various embodiments and/or components, for example, the modules, elements, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (GPUs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A vehicle control system comprising:
a steering wheel;
one or more controls actuatable by an operator;
an integrated steering wheel controller having a processor and connected to the one or more controls and to a vehicle computer; and
an indicator corresponding to the one or more controls and providing a visual indication of a state of an operation or function associated with the one or more controls.

2. The vehicle control system of claim 1, wherein the indicator is a back illumination component.

3. The vehicle control system of claim 1, wherein the indicator comprises a multi-color light emitting diode (LED).

4. The vehicle control system of claim 3, wherein the integrated steering wheel controller is configured to change a color of the multi-color LED based on the state of the operation or function associated with the control.

5. The vehicle control system of claim 1, further comprising a plurality of controls and wherein the integrated steering wheel controller is connected to the plurality of controls with N communication lines and to the vehicle computer with M communication lines, wherein M is less than N.

6. The vehicle control system of claim 5, wherein the plurality of controls comprise buttons on a front face of the steering wheel.

7. The vehicle control system of claim 1, wherein the integrated steering wheel controller includes a wiring harness with a connector configured to connect to a complementary connector of a clock spring.

8. The vehicle control system of claim 1, wherein the integrated steering wheel controller is mounted to the steering wheel.

9. The vehicle control system of claim 1, wherein the integrated steering wheel controller is formed within a body of the steering wheel.

10. The vehicle control system of claim 1, wherein the integrated steering wheel controller is a light emitting diode (LED) microcontroller (MCU).

11. The vehicle control system of claim 1, wherein the vehicle computer comprises a main vehicle electronic control unit (ECU).

12. The vehicle control system of claim 1, wherein the operation or function is not readily apparent to the operator.

13. A steering wheel assembly comprising:
a steering wheel;
an airbag module configured to be coupled to the steering wheel;
a microprocessor mounted within the steering wheel and connected to a vehicle computer; and
a plurality of backlit control buttons on the steering wheel connected to the microprocessor and configured to be actuated by an operator, wherein a color of the backlighting corresponds to an activation state of an operation or function controlled by the backlit control button.

14. The steering wheel assembly of claim 13, wherein the plurality of backlit control buttons comprise multi-color light emitting diodes (LEDs).

15. The steering wheel assembly of claim 14, wherein the microprocessor is an LED controller.

16. The steering wheel assembly of claim 13, wherein the microprocessor is connected to the plurality of backlit control buttons with N communication lines and to the vehicle computer with M communication lines, wherein M is less than N.

17. The steering wheel assembly of claim 13, further comprising a wiring harness connecting the microprocessor to a clock spring.

18. A method for providing vehicle function and indication control, the method comprising:
receiving a control input at a steering wheel for a vehicle;
communicating a control signal corresponding to the received control input from a processor within the steering wheel to a main computer of the vehicle;
transmitting a confirmation signal from the main computer to the processor within the steering wheel indicating activation of an operation or function corresponding to the received control input; and
providing a visual confirmation at the steering wheel based on the confirmation signal.

19. The method of claim 18, further comprising receiving the control input at a backlit button of the steering wheel and changing a color of the backlighting based on the confirmation signal.

20. The method of claim 18, further comprising receiving the control input at a button of the steering wheel connected to the processor of the steering wheel with N communication line and performing the communicating and transmitting using M communication lines, wherein M is less than N.
